(19) United States
(12) Patent Application Publication
(10) Pub. No.: US 2017/0232349 A1
(43) Pub. Date: Aug. 17, 2017

(54) Sports Officiating Simulator

(71) Applicant: Jacques Miles, Harrisburg, PA (US)

(72) Inventor: Jacques Miles, Harrisburg, PA (US)

(21) Appl. No.: 15/045,244

(22) Filed: Feb. 16, 2016

(51) Int. Cl. A63F 13/812; A63F 13/215; A63F 13/25

(52) U.S. Cl. CPC A63F 13/812; A63F 13/25; A63F 13/215

(57) ABSTRACT

A method for measuring the sports knowledge of a fan is disclosed. The method includes the steps of (a) displaying game content over a medium; (b) receiving and recording information in response to the displayed game content associated with one or more User Generated Rulings and/or one or more User Challenges in response to the displayed game content; (c) repeating steps (a) and (b) until a set time period expires; and (d) calculating a score based on the information received associated with one or more User Generated Rulings and/or one or more User Challenges.

### CROSS-REFERENCE TO RELATED APPLICATIONS

The present Utility patent application claims priority benefit of the U.S. provisional application for patent Ser. No. 62/117,095 filed on Feb. 17, 20015 under 35 U.S.C. 119(e). The contents of this related provisional application are incorporated herein by reference for all purposes.

### FIELD OF THE INVENTION

The present invention relates to an apparatus and one or more methods for simulating the experience of a coach and/or sports official for a variety of sports as well as methods for testing a fans knowledge of one or more sports.

### BACKGROUND

All sports are governed by rules. Sports rules comprise both a written rule and an interpretation of the rule. For every sport and at every level of sport—youth league, middle school, high school, college, semi-professional and professional, one or more persons administer the game and enforce rules during the sporting contest.

Knowledge of sports rules and their interpretations are not just important for officials. All of a sports' participants—players, coaches, fans, etc.—are better off with an improved knowledge and understanding of the rules. Players and coaches can gain a competitive advantage through a thorough understanding of sports rules. And the experiences of fans can be improved by an enhanced understanding of sports rules.

If sports rules were not complex enough, new rules are constantly adopted and existing rules are always being amended or interpreted differently. A fun and innovative method for improving sports related knowledge including knowledge of sports rules is sorely needed. The present invention provides such a method.

Managing game situations successfully is also vital for winning coaches and referees. And fans love to demonstrate their superior knowledge of a sport including interpretations of rules, the history of a sport, key sports facts and figures, etc.

The present invention provides such a method for fans, coaches, referees, etc. to demonstrate their superior knowledge of a sport.

### SUMMARY OF THE INVENTION

In a non-limiting embodiment, the present invention is a method for simulating the experience of a coach and/or sports official comprising: (a) displaying game content on a medium; (b) receiving and recording information in response to the displayed game content associated with one or more Rulings and/or one or more User Challenges; (c) repeating steps (a) and (b) until a set time period expires; and (d) calculating a score based on the information received associated with one or more Rulings and/or one or more User Challenges.

In another non-limiting embodiment, the present invention is a method for measuring the sports knowledge of a fan comprising: (a) displaying game content on a medium; (b) receiving and recording information in response to the displayed game content associated with one or more Rulings and/or one or more User Challenges; (c) repeating steps (a) and (b) until a set time period expires; and (d) calculating a score based on the information received associated with one or more Rulings and/or one or more User Challenges.

### DESCRIPTION OF THE INVENTION

The present invention is a method for simulating the experience of a coach and/or sports official comprising (a) displaying game content over a medium; (b) receiving and recording information in response to the displayed game content associated with one or more User Generated Rulings and/or one or more User Challenges in response to the displayed game content; (c) repeating steps (a) and (b) until a set time period expires; and (d) calculating a score based on the information received associated with one or more Rulings and/or one or more User Challenges.

The described invention also encompasses a method for measuring the sports knowledge of a fan.

According to the present invention, game content is displayed on one or more mediums. The medium can be a visual medium such as a screen (i.e., computer screen, television screen, etc.); an audible medium such as loudspeakers; a combination of visual medium and an audible medium; etc.

The game content comprises multiple plays and/or sequences of events from one or more sporting contests. The game content can be either live sports action or recorded sports action. The game content can be from a variety of sports including, but not limited to, football, basketball, soccer, baseball, hockey, cricket and rugby. The game content can be from any level of sport including youth league, high school, college, professional, etc.

In a non-limiting embodiment, the game content is live action from a game/sporting contest being played in the moment or with a slight delay relative to the display of the game content.

In a non-limiting embodiment, the game content comprises recorded content from a previously played game(s)/sporting contest. The game content can comprise multiple plays and/or sequences of events from one or more previously recorded sporting contests/games. The recorded game content can be edited before it is displayed.

In a non-limiting embodiment, when recorded game content is displayed, the various plays and/or sequences of events can run in a semi-continuous or continuous manner. This provides a User experience similar to a live game in terms of look and feel.

In a non-limiting embodiment of the invention, the game content is edited in a manner which reduces or eliminates evidence of the actions of officials such as the throwing of a flag, the blowing of a whistle, the enforcement of a penalty, etc.

In another non-limiting embodiment of the invention, the game content is edited in a manner that enhances the simulation of a sports officiating experience. For example, one or more sections of the game content can be digitally enhanced to sharpen the audio/video of the game content or increase the scale of objects in the game content (i.e., make objects in the game content appear larger and/or make images more well-defined).

In a non-limiting embodiment, the displayed game content can be from one or more vantage points/viewing angles. The display of game content is not restricted to the view from any particular angle or vantage point.

Game content can also comprise video and/or audio associated with a person, a place, a team, an object, etc. For example, the game content can be video showing one or more persons. As another example, the game content can be audio of a person speaking or other. As yet another example, the game content can be video and/or photos of a team or a stadium or a landmark or a piece of equipment or almost anything.

According to the present invention, the system can both generate/display certain information and receive certain other information. In response to the game content displayed, the system receives various information entered by a User. This information entered by a User comprises a User Generated Ruling and/or Challenge Information. Challenge Information is associated with a User Challenge. The system can record this information.

A User Generated Ruling comprises information entered by a User and received by the system associated with a penalty/foul/infraction, a scoring play or other subjective, sports specific decision in response to displayed game content. User Generated Rulings can include all information related to a penalty/foul/infraction, a scoring play and/or other subjective, sports specific decision. User Generated Rulings are typically sports specific. Non-limiting examples of various User Generated Rulings for different sports are provided below.

A User Generated Ruling is entered by a User and received by the system. User Generated Rulings may be entered into the system in response to a system generated prompt (prompted) or there may be no prompt (unprompted).

A system generated prompt works in the following manner. After an event(s) has occurred in the displayed game content, a prompt is shown requesting certain input from a User relating to the game content which was displayed. A prompt can be displayed/shown on a screen and/or announced via audible means.

A User may also observe something in the displayed game content—a penalty, a scoring play or other—and enter information into the system without a prompt. In this context, there is a User Generated Ruling with no prompt.

In addition to User Generated Rulings, there are also System Generated Rulings. System Generated Rulings are self-explanatory in that they are generated by the system (not a User) and are displayed and/or announced by the system. They can be programmed into the system.

When a System Generated Ruling is displayed and/or announced during the display of the game content, a User has an opportunity to Challenge the System Generated Ruling by using a User Challenge and enter associated Challenge Information—or not. The system can receive and/or record such User Challenge and associated Challenge Information. Challenge Information is associated with every User Challenge. The Challenge Information entered by a User can correspond to every element/component of information that makes up the System Generated Ruling.

The Challenge Information received by the system during a User Challenge is the same type of information encompassed by a System Generated Ruling for a given sport—it comprises every component of information that makes up the System Generated Ruling. Such information comprises all information associated with a penalty, a scoring play and/or other subjective, sports specific decision. Such information may also include a person's name, the name of a team, dates, various facts, various statistics, etc.

A User has various ways to affirm (not challenge) a System Generated Ruling. According to the invention, a User can take no action or do nothing to affirm a System Generated Ruling.

In a non-limiting embodiment, the Challenge Information comprises an affirmation or a reversal of the System Generated Ruling.

After using a User Challenge but before entering Challenge Information, one or more instant replays of the displayed game content which is the subject of the System Generated Ruling can be selected and/or viewed by the User.

A First User Challenge/First Challenge Information is associated with a first System Generated Ruling; a Second User Challenge/Second Challenge Information is associated with a second System Generated Ruling; and so on and so on.

In a non-limiting embodiment, there are a finite number of User Challenges provided to a User. For example, twenty five (25) or less, or twenty (20) or less, or fifteen (15) or less, or ten (10) or less User Challenges, or five (5) or less User Challenges are provided. Any number of User Challenges may be provided.

In a non-limiting embodiment, the User takes action to initiate a User Challenge in response to a specific System Generated Ruling which is displayed and/or announced. The system receives/records this information. Additionally, the User can enter Challenge Information associated with the User Challenge by affirming and/or modifying every piece of information associated with the System Generated Ruling. The User can enter such Challenge Information via a list, a scroll down menu or similar. Or the User can type in the Challenge Information using a keyboard or speak the information into a microphone.

In a non-limiting embodiment, the system receives and/or records information entered by the User in response to the displayed game content associated with one or more System Generated Rulings—both User Challenges and associated Challenge Information.

The exact nature of the information received by the system comprising a User Generated Ruling or Challenge Information depends on the sport that is being displayed in the game content. Ruling and Challenge Information typically relates to a rules infraction/penalty/foul (includes the penalty, the enforcement of the penalty and related), a decision regarding a scoring play and other subjective, sports specific decisions which must be made during the course of a game.

As stated above, Challenge Information entered by a User and received/recorded by the system can relate to a person, a place, a team, etc.—essentially anything displayed in video and/or photo as well as anything identifiable via audio.

For football, for example, rules infractions include, but are not limited to, holding, clipping, grabbing a facemask, roughing the passer, offsides, false start, etc. Infractions/violations of the rules are spelled out in the official rule book for the level of play. Scoring plays include touchdowns, extra points and field goals. Other subjective, sports specific decisions which must be made during football games include, but are not limited to, complete/incomplete passes, fumbles, recoveries of fumbles and similar.

For soccer, for example, fouls include kicking an opponent; tripping; jumping into an opponent (like when you are going for a header); charging into an opponent; pushing; tackling from behind; tackling an opponent and you make contact with the player prior to making contact with the ball; holding; touching the ball with your hands (if you are not the goalkeeper); etc. Infractions/violations of the rules are spelled out in the official rule book for the level of play. Scoring plays include goals. Other subjective, sports specific decisions which must be made during soccer games include, but are not limited to, giving a caution or yellow card; giving a red card; awarding an indirect free kick; awarding a direct free kick; etc.

For basketball, for example, rules infractions include, but are not limited to, the following: double dribble, traveling violation, blocking foul, charge, goal tending, etc. Infractions/violations of the rules are spelled out in the official rule book for the level of play. Scoring plays are field goals and free throws. Other subjective, sports specific decisions which must be made during basketball games include, but are not limited to, last second shots, stepping out of bounds, fouls in the act of shooting, 2 or 3 point field goals and similar.

For hockey, for example, penalties include the following classes: minor/bench minor penalties; major penalties; misconduct penalties; match penalties; and penalty shot. Infractions/violations of the rules are spelled out in the official rule book for the level of play. Scoring plays include goals. And other subjective, sports specific decisions which must be made during hockey games are well known in the art and in the sport of hockey.

For baseball, for example, infractions/violations of the rules are spelled out in the official rule book for the level of play. Scoring plays include runs. And other subjective, sports specific decisions which must be made during baseball games are well known in the art and in the sport of baseball.

For cricket, for example, infractions/violations of the rules are spelled out in the official rule book for the level of play. Scoring plays include runs. And other subjective, sports specific decisions which must be made during cricket matches are well known in the art and in the sport of cricket.

For rugby, for example, infractions/violations of the rules are spelled out in the official rule book for the level of play. Scoring plays include a try; a penalty try; a converted try; a field goal; a penalty goal; etc. And other subjective, sports specific decisions which must be made during rugby matches are well known in the art and in the sport of rugby.

When the system is receiving information in the form of a Ruling and/or Challenge Information, the display of game content can be temporarily stopped or paused. After the system receives the information, the display of game content can be resumed at an appropriate point as defined by the system or other.

In a non-limiting embodiment, the game content is displayed for a fixed time period. In a non-limiting embodiment of the invention, the time period ranges from 2 to 30 minutes, or from 2 to 20 minutes, or from 2 to 10 minutes, or from 2 to 5 minutes. The time period can be the entire length of an actual sporting contest/game. There is no limitation on the time period for display of the game content. According to the present invention, one or more of the steps recited herein can be repeated in any order until the time period expires.

According to the present invention, a score can be calculated after the time period for display of the game content expires. The score can be based on the information received by the system associated with User Generated Rulings and Challenge Information. The score can reflect a degree/level of correctness of the information associated with User Generated Rulings and Challenge Information received by the system as compared to a standard or control. There can be a level of correctness associated with all User Generated Rulings and Challenge Information.

There can even be a level of correctness associated with User Challenges pertaining to whether or not the displayed game content was controversial enough or other to justify the use a User Challenge. Positive points can be awarded for “good” User Challenges. Points can be subtracted for “poor” User Challenges”. “Good” and “poor” challenges can be set/defined by any means. For example, “good” and “poor” challenges can be defined by a referee(s), an officiating body or other.

In a non-limiting embodiment, a score is generated by comparing the information received by the system against a standard representing “correct answers” as determined by an authoritative person or body such as one or more professional referees for a given sport, the National Collegiate Athletic Association (NCAA), the National Football League (NFL), the National Basketball Association (NBA), the Canadian Football League (CFL), the English Premier League, etc.

In a non-limiting embodiment of the invention, the score is displayed on the screen and/or audibly conveyed.

According to the present invention, while the game content is being displayed, a first input signal is received from a first input device. Upon receipt of the first input signal, the display of the game content can be stopped or paused. The first input signal is received and transmitted using methods which are well known in the art.

The first input device can be a keyboard, joystick, or other similar device as is well known in the art. In a non-limiting embodiment of the invention, the first input device is a whistle or other device capable of making sound.

In the practice of the invention, the various input and output devices referred to herein can be connected using various input/output connectors and ports which are well known in the art. The various input/output devices can communicate with the personal computing device by any suitable means such as, but not limited to, a wireless system such as “Bluetooth”, cable, etc.

In a non-limiting embodiment of the invention, after the first input signal is received, a second input signal is received. The second input signal is generated by a second input device. The second input signal is received and transmitted using methods which are well known in the art. In the practice of the invention, the second input signal can comprise information about a specific infraction, information about a scoring play and/or information pertaining to other subjective, sports specific decisions and related information.

After the first and second input signals are received by the system, the display of the game content resumes. Ideally, the display of game content resumes at the next point in the game that enables a smooth transition from where the first input signal was received. The display of game content continues until another first input signal is received or the time period for the display of game content expires.

In practice, the method of the present invention will be implemented using a system like a personal computing device or similar. The method of the invention will performed on a personal computer or similar using one or more software programs or similar. The software program(s) can be written on a DVD or other programmable device as in known in the art so that it can be read and actuated by a personal computing device or other. The practice of this invention is not limited to any particular computing platform such as a personal computer using a Windows operating system, a Sony PSP, a Microsoft X Box, a Nintendo gameboy, a mobile device, a smart phone, etc. The present invention can be practiced on any platform.

According to the present invention, the processing (transmitting, receiving, etc.) of the various input and output signals described above is accomplished using methods which are well known in the art.

The personal computing device utilized to practice the present invention can contain one or more video and/or graphic systems including components for receiving compressed and uncompressed graphics and video and for processing the received graphics and video into displayable format. The graphic display system can be any one capable of processing video input signals that may include analog video signals, digital video signals, etc. The analog signals can be, for example, NTSC, PAL and SECAM signals or any other conventional type of analog signal. The digital signals can be decoded MPEG signals or other format of digital video output.

Suitable methods for processing audio and video signals are well known in the art. A suitable method is described in U.S. Pat. No. 6,728,312 assigned to Forgent Networks, Inc. (Austin, Tex.).

The present invention can be used in a variety of ways and in a variety of settings. For example, the present invention can be used as a simulator/training tool for coaches and/or sports officials at all levels and for aspiring coaches and/or sports officials. In another example, the invention can be used to educate players, coaches, fans, and/or others about the rules of a particular sport and possibly develop a lifelong fan. As another example, the invention can be used to introduce or grow a sport in a new market. The invention could be used to grow cricket or rugby in the United States. And, the invention can be used to evaluate referee prospects and referees. The invention can be implemented in the United States and internationally.

Some terms are used throughout this specification. Definitions for these terms are provided below.

As used herein, the term “official” refers to a person who administers a game and enforces the rules during the game (i.e., a football game, a basketball game, a baseball game, a hockey game, a soccer game, a boxing match, a rugby match, etc.). Terms such as “referee”, “umpire”, “head linesman”, etc. are considered to be synonymous with the term official.

As used herein, the term “penalty” refers to a violation of a particular rule in a given sport. Terms such as “infraction”, “foul”, etc. are considered to be synonymous with the term penalty.

As used herein, the term “User” refers to a person viewing the displayed game content and/or interacting with the displayed game content as described in this invention. The score is representative of the performance of the User in the simulation.

As used herein, the term “personal computing device” refers to a computer or other device having a processor and memory capable of performing the method of the invention. The term personal computing devices such as computers, smartphones and tablets. The term encompasses various models made by manufactures such as Dell computer, Gateway computer, Apple, etc. The term also includes video game consoles such as the X-Box from Microsoft, the Playstation from Sony, PSP from Sony, the Gameboy system from Nintendo, etc. Another example of a suitable personal computing device is a television set having a set top box or TiVo.

As used herein, the term “displaying” has its conventional meaning and encompasses video, graphics, and/or audio content. Video content can be displayed on a medium such as a television screen, a computer screen, etc. Audio content can be displayed over a medium such as one or more speakers. Audio content can be displayed simultaneously with video content.

It will be readily appreciated by those skilled in the art that modifications may be made to the invention without departing from the concepts disclosed in the foregoing description. Such modifications are to be considered as included within the scope of the invention. Accordingly, the particular embodiments described in detail hereinabove are illustrative only and are not limiting as to the scope of the invention, which is to be given the full breadth of the appended claims and any and all equivalents thereof.

I claim:

1. A method for simulating the experience of a coach and/or sports official comprising:
(a) displaying game content on a medium;
(b) receiving and recording information in response to the displayed game content associated with one or more User Generated Rulings and/or one or more User Challenges;
(c) repeating steps (a) and (b) until a set time period expires; and
(d) calculating a score based on the information received associated with one or more User Generated Rulings and/or one or more User Challenges.

2. The method according to claim 1 wherein the game content is from a football game, a basketball game, a baseball game, a hockey game, a game of cricket, a game of rugby or a soccer game.

3. The method according to claim 1 wherein the recited steps are accomplished using a personal computing device.

4. The method according to claim 1 wherein the score is generated by comparing the information received by the system against a standard representing “correct answers” as determined by an authoritative person or body.
